(19) United States
(12) Patent Application Publication
(10) Pub. No.: US 2002/0038425 A1
(43) Pub. Date: Mar. 28, 2002

(54) Distributed order reception system, reception server, content server, distributed order reception method, and computer program product

(76) Inventor: Shin-Ichi Kanno, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/961,374

(22) Filed: Sep. 25, 2001

(30) Foreign Application Priority Data
Sep. 28, 2000 (JP) 2000-297434

(51) Int. Cl. H04L 9/00

(52) U.S. Cl. 713/185

(57) ABSTRACT

An order reception system configured to accept an order for a content, which is requested from a client via a network is disclosed. The system includes a plurality of content servers each of which stores the same content, and a reception server having a first device configured to select one of the content servers based on load conditions thereof, a second device configured to receive a first access request relating to the order from the client, and a third device configured to issue a permission ticket, wherein the permission ticket locates the selected one of content servers on the network.

### CROSS-REFERENCE TO RELATED APPLICATIONS

This application is based upon and claims the benefit of priority from the prior Japanese Patent Application No. 2000-297434, filed Sep. 28, 2000, the entire contents of which are incorporated herein by reference.

### BACKGROUND OF THE INVENTION

1. Field of the Invention

The present invention relates to a distributed order reception system capable of distributing loads when orders are rushing. The present invention also relates to a reception server, content server, a distributed order reception method, and a computer program product.

2. Description of the Related Art

In recent years, with rapid spread of the Internet and the computer technology, ordering commercial goods from a terminal apparatus of a client through the Internet has been very naturally carried out. Commercial goods dealt on the Internet are not only tangible materials. For example, software can be ordered from a given e-commerce site on the WWW. In this case, the ordered software is subjected to closing account processing for merchandise purchase and can be then directly downloaded from the Internet.

The ordering system, which exclusively accepts orders from terminal apparatuses of clients, makes a plurality of content servers a request for performing processing concerning actual orders.

FIGS. 13 and 14 show conventional system structural examples. In FIG. 13, orders from a plurality of clients 62a, 62b, 62c, 62d, . . . connected to the Internet 61 are first accepted by a DNS (Domain Name Service) server 63, and then allocated to, for example, three content servers 64a, 64b and 64c, thereby performing processing for orders.

The DNS server 63 carries out so-called round robin type load distribution, by which orders are sequentially allocated to the content servers 64a, 64b and 64c, every time it accepts an order. For example, when there is an order from the client 62b (S61), this client is instructed to access the content server 64b (S62), the client 62b accesses the content server 64b (S63), and ordering or downloading the software is performed with respect to this server (S64).

In this method, however, since the orders are sequentially allocated to the respective content servers from the DNS server, even if there is a content server whose load is large, such a content server cannot be avoided. Further, the server distributed from the client side can be easily specified, and the client can access the content server even if the DNS server cannot perform allocation. Therefore, when the load to the content servers becomes very high, even if connection is tried to be restricted, the client may possibly ignore such restriction, and appropriate load distribution is impossible.

On the other hand, as shown in FIG. 14, when clients 71a, 71b, 71c and 71d are connected to the Internet 71 and content servers 74a, 74b and 74c are connected through a network device such as a switch 73, since there are restrictions on the network topology, the traffic on the network can not be distributed, otherwise concentrated to the switch 73.

### BRIEF SUMMARY OF THE INVENTION

As described above, in the conventional reception system on the Internet, appropriate load distribution cannot be carried out when orders are rushing. In order to eliminate the above-described problem, it is therefore an object of the present invention to provide a distributed order processing system and its method capable of appropriately distributing loads even if orders are rushing.

To achieve this aim, according to one embodiment of the present invention, there is provided an order reception and content transmission system configured to accept an order for a content, which is requested from a client via a network. This system comprises a reception server configured to issue a permission ticket to the client upon receiving a first access request relating to the order from the client, and a content server configured to transmit the content to the client in response to a second access request sent from the client using the permission ticket.

Furthermore, there is provided another system comprising a plurality of content servers each of which stores the same content, and a reception server. The reception server includes a first device configured to select one of the content servers based on load conditions thereof, a second device configured to receive a first access request relating to the order from the client, and a third device configured to issue a permission ticket to the client, wherein the permission ticket locates the selected one of content servers on the network.

### BRIEF DESCRIPTION OF THE SEVERAL VIEWS OF THE DRAWING

FIG. 1 is a diagram of an order reception system according to one embodiment of the present invention;

FIG. 2 is a view showing a flow of an order in the system shown in FIG. 1;

FIG. 3 is a block diagram showing modules of a reception server to provide a load sharing functionality according to the embodiment of the present invention;

FIG. 4 is a block diagram showing modules of a content server to provide a load sharing functionality according to the embodiment of the present invention;

FIG. 5 is a sequence diagram showing a communication between a client and servers in the order reception system according to the embodiment of the present invention;

FIG. 6A is a flowchart showing a process of the reception server according to the embodiment of the present invention;

FIG. 6B is a flowchart showing a process of the content server according to the embodiment of the present invention;

FIG. 6C is a flowchart showing a process of a client according to the embodiment of the present invention;

FIG. 7 is a view showing an example of a URL included in a permission ticket returned from the reception server to the client;

FIG. 8 is a view showing another example of the URL included in the permission ticket returned from the reception server to the client;

FIG. 9 is a view showing still another example of a URL included in the permission ticket returned from the reception server to the client;

FIG. 10 is a view showing still another example of a URL included in the permission ticket returned from the reception server to the client;

FIG. 11 is a block diagram showing modules of a reception server to provide for a load sharing functionality according to another embodiment of the present invention;

FIG. 12A is a flowchart showing a process of a reception server according to another embodiment of the present invention;

FIG. 12B is a flowchart showing a process of a content server according to another embodiment of the present invention;

FIG. 12C is a flowchart showing a process of a client according to another embodiment of the present invention;

FIG. 13 is a diagram of a conventional order reception system; and

FIG. 14 is a diagram of another conventional order reception system.

### DETAILED DESCRIPTION OF THE INVENTION

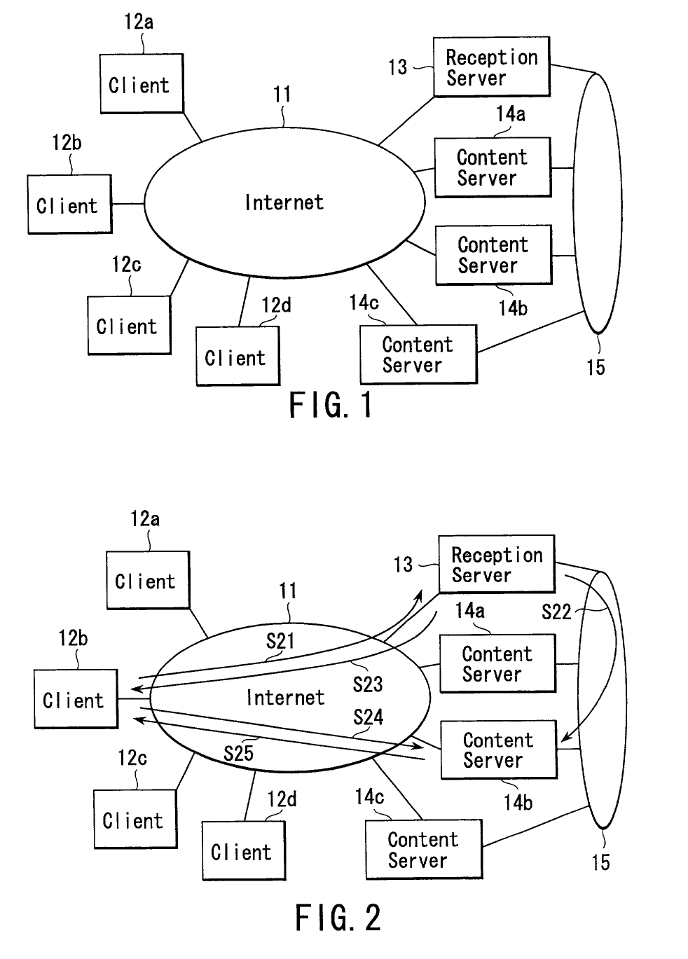

Embodiments according to the present invention will now be described hereinafter with reference to the accompanying drawings. FIG. 1 shows a diagram of a distributed order reception system according an embodiment of the present invention. In FIG. 1, reference numeral 11 denotes the Internet, and clients 12a, 12b, 12c and 12d requesting orders and the like are connected to the Internet 11. Further, a reception server 13 for receiving orders from these clients and content servers 14a, 14b and 14c for actually processing these orders are also connected to the Internet 11. Furthermore, the reception server 13 and the content servers 14a, 14b and 14c are also connected to a network 15.

As shown in FIG. 2, a certain client (for example, 12b) issues an order to the reception server 13 via the Internet 11 (S21). The reception server 13 accesses the content servers 14a, 14b, and 14c through the network 15, and grasps the load condition of these servers. When receiving the order (S21), the reception server 13 selects one content server with the lowest load, and determines it as a server (for example, 14b), which processes the order concerned (S22). At this time, the reception server 13 notifies the required information so that client 12b, which issued the order, may access the content server 14b and can receive contents (S23). In response to the notification, the client 12b accesses the content server 14b (S24), and the contents, which respond to the order, are received from content server 14b (S25).

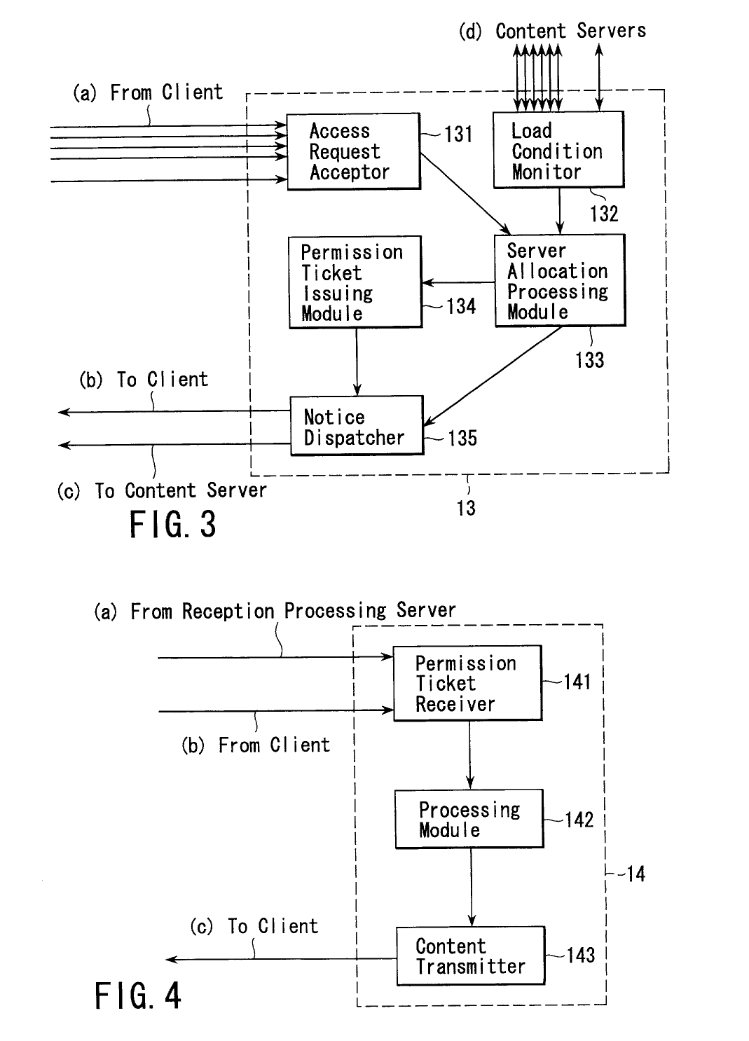

Referring next to FIG. 3, the reception server 13 is provided with the modules, which includes an access request acceptor 131, a load condition monitor 132, a server allocation processing section 133, a permission ticket issuing module 134, and a notice dispatcher 135.

The access request acceptor 131 accepts access requests relating to orders from two or more clients through the Internet 11. The load condition monitor 132 monitors the load condition of these content servers through the network 15. The server allocation processing section 133 determines an appropriate content server to actually process a certain access request, which is accepted by the acceptor 131, in view of the load condition notified by the load condition monitor 132. The permission ticket issuing module 134 issues a permission ticket as the information required in order that the client may access the assigned content server about the access request. The detail of the permission ticket will be described later.

The notice dispatcher 135 dispatches the permission ticket issued in the module 134 to the client that made the access request. The notice dispatcher 135 also dispatches the authentication information relating to the permission ticket to the content server so that the authorized client accessed using the permission ticket may not be wrongly refused. As for the authentication method of the client by the content server using the permission ticket, setting flexibly in the viewpoint of the system configuration is desirable. This includes a brief process in which the content server does not perform any authentication processing target at clients. In this case, the permission ticket notified to the client contains at least an URL of the content server. On the other hand, in strict authentication, the clients which can access the content server are justifiably regulated and the time zone which can make access is also regulated.

Generally, the notice of the permission ticket from the notice dispatcher 135 to the client may be a response to an access request by http, which is given to the access request section 131 from the client. This response, however, be a message send via the E-mail system. This is the same also about messaging between the reception server 13 and the content servers 14a, 14b, and 14c.

Next, with reference to FIG. 4, the content server 14 (14a, 14b, and 14c are named generically, and referred to as 14) is equipped with the modules, which includes a permission ticket receiver 141, a request processing module, and a content transmitter 143. The permission ticket receiver 141 receives the permission ticket from the client 12. This client 12 is the client, which received the permission ticket from the reception server 13 and accessed the content server 14. The permission ticket receiver 141 knows that this client 12 receives cession of the permission ticket in advance, and its contents, by receiving the corresponding notice from the reception server 13.

The request-processing module 142 performs some judgment processing as to whether outstanding access from the client 12 is permitted based on the permission ticket. This judgment processing includes judgment of the effectiveness of the permission ticket. When access is permitted, the content transmitter 143 transmits the contents concerning the order specified from the client 12 to the access request through the Internet 11. In the simplest example of the system configuration, the permission ticket includes no authentication information. In this case, in response to the request from the client, the content server is unconditional and transmits the contents.

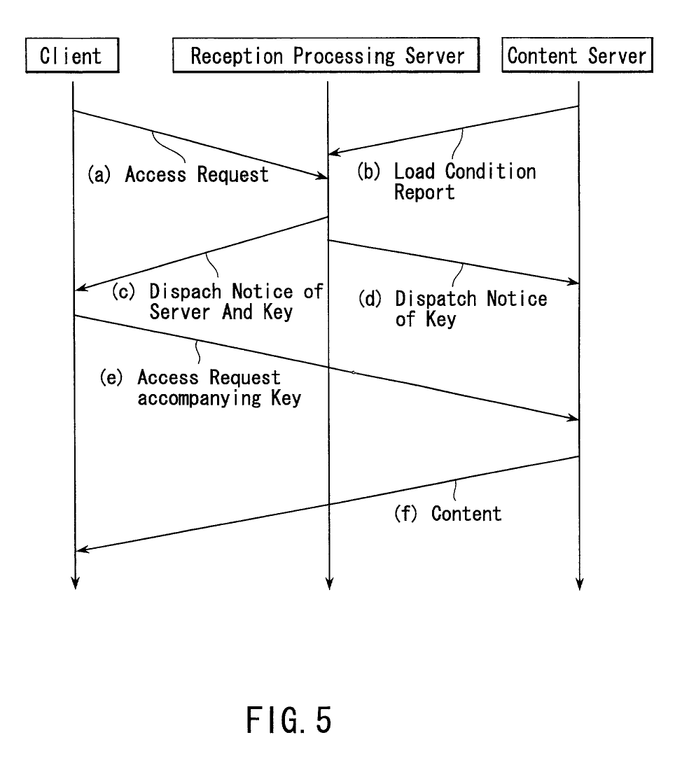

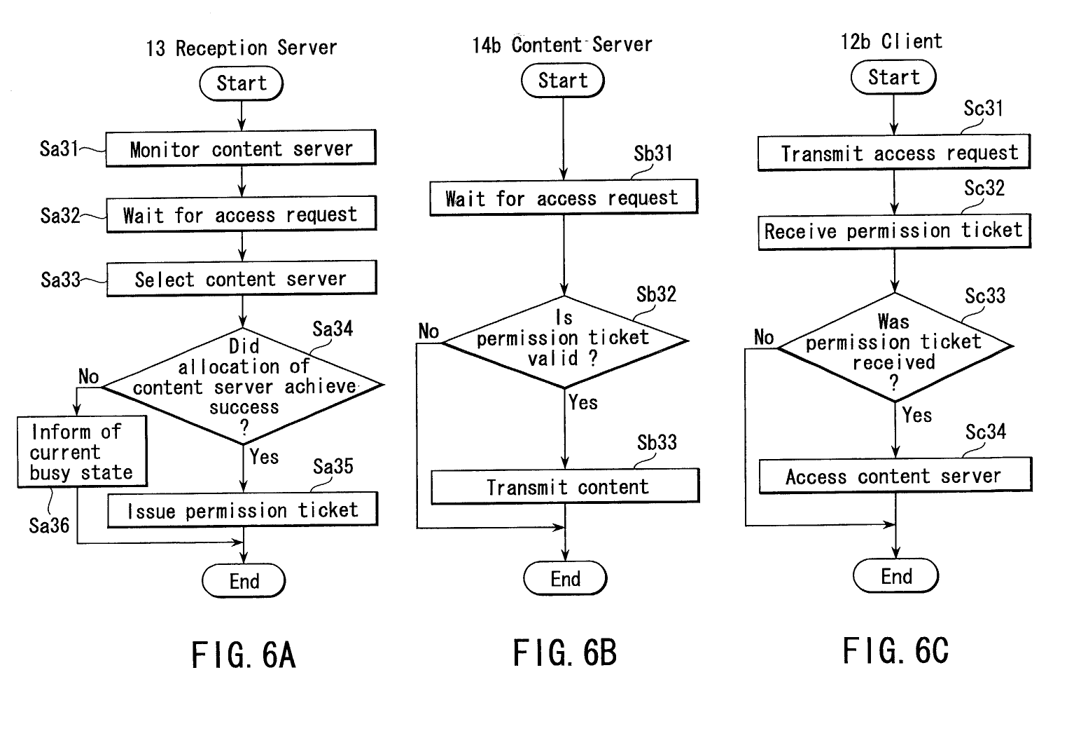

FIG. 5 is a sequence diagram showing a communication between a client and servers in the order reception system according to the embodiment of the present invention. FIGS. 6A to 6C are flowcharts showing a process of the reception server, a process of the content server, and a process of a client, respectively.

At first, as shown in FIG. 6A, the reception server 13 monitors the load conditions of the content servers 14a, 14b and 14c through the network 15 (Sa31). In order to evaluate the load condition of each content server by the reception server 13, the reception server 13 can measures a number of clients to which services are provided by the respective content servers or makes reference to a memory quantity used by a computer constituting each content server.

Next, as shown in FIG. 6C, for example, the client 12b requests an order to the reception server 13 (Sc31). At this moment, the reception server 13 and the content server 14b wait for the access request (See “Sa32” in FIG. 6A, also “Sb31” in FIG. 6B). The client 12b uses a WWW browser to request an order in accordance with, e.g., the http protocol. Specifically, a user inputs a URL (Uniform Resource Locator) of the reception server 13 to the WWW client 12b and commands access to the reception server 13.

In response to the access request, the server allocation processing module 133 in the reception server 13 selects (Sa33), for example, the content server 14b having relatively small load with reference to load conditions of content servers 14a, 14b, and 14c evaluated in Sa31.

Subsequently, the reception server 13 confirms whether or not such allocation to the content server 14b has achieved success (Sa34). If allocation to the content server 14b has achieved success (permitted), the permission ticket issuing module 134 in the reception server 13 issues a permission ticket to the client 12b. The notice dispatcher 135 then dispatches a notice to the content server 14b of issue of the permission ticket to the client 12b (Sa35).

If all the content servers have the high loads and are busy in Sa34, the reception server 13 informs the client 12b of the current busy state in Sa36 and terminates the processing.

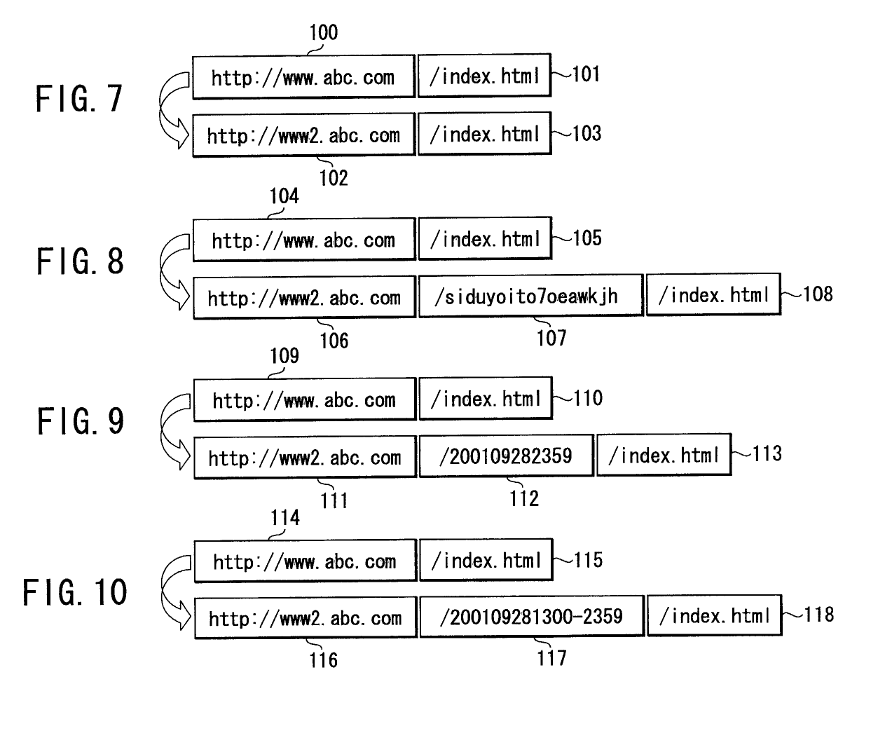

A form of the URL to the content server as shown in FIG. 7 for example, represents the permission ticket. As shown in FIG. 7, reference numeral 100 denotes an address part of the reception server, reference numeral 101 denotes a detailed location of the content, and the combination of 100 and 101 corresponds to the URL subject to one access request. With reference to this URL of the access request, the reception server 13 issues the permission ticket comprising the parts of 106 and 107 and dispatches the ticket to the client. Note that reference numeral 106 denotes an address part of the content server, 107 denotes a part of the permission ticket, and 108 denotes a detailed location of the content which is stored in the content server. As it is recognized from FIG. 7 that the address parts 100 and 106 defers each other and the client can access the allocated content server based on the address part 106.

Encrypting with appropriate codes or scrambling all or any combinations of an address of the client, an access permission time and an end time obtains the ticket part 107.

As shown in FIG. 6C, the client 12b having received the permission ticket in Sc32 accesses the content server 14b in accordance with the http protocol in the step Sc33 and Sc34. At this time, the ticket part 108 and/or the address part 108 of the permission ticket is transmitted to the content server 14b.

As shown in FIG. 6B, the content server 14b receives the ticket part 107, which is transmitted from the client 12b in accordance with the http protocol. This ticket part 107 is subject to be decrypted or de-scrambled in the content server 14b. The content server 14b, then, determines that the permission ticket is valid with reference to information reported from the reception server 13 in advance (Sb32).

The content server 14b transmits the content to the client 12b when the validity of the permission ticket is verified (Sb33).

The permission ticket issued by the reception server in the above-described manner is issued every time there is access from the client for the order request, or nullified every time the order processing is terminated.

Incidentally, if the permission ticket is not valid as a result of verification of the permission ticket in Sb32 (for example, an expired permission ticket), the content server 14b disconnects communication with the client server 12b.

Upon termination of the order processing, when information representing that the permission ticked used before that processing is invalid is registered to the content server, the content server can deny access performed by using the permission ticket registered as an invalid permission ticket. As a result, the fraudulent access appropriating the issued permission ticket can be prevented.

In the above embodiment, monitoring of the load condition of each content server by the reception server 13 is performed by the network 15 different from the Internet 11. Moreover, when the permission ticket for permitting connection is issued to the client, the reception server 13 informs the corresponding server among the content servers 14a to 14c of issue of the permission ticket through the network 15.

As described above, according to the structure in which the reception server 13 monitors the content servers 14a to 14c and informs of issue of the permission ticket through the independent network 15 different from the Internet 11, the security can be improved. Presupposing that the necessary security is achieved, it is of course possible to adopt the structure that the reception server 13 monitors the content servers 14a to 14c and informs of issue of the permission ticket through the Internet 11 without providing the network 15.

Further, in the above embodiment, the load conditions of the respective content servers 14a to 14c are monitored, and processing of orders from the clients 12a to 12c is allocated to the content server whose load is small. However, it is also preferable to select the content servers 14a to 14c by taking the distance from the reception server 13 into consideration. For example, if there are a plurality of content servers whose loads are on substantially the same level when a given client among the clients 12a to 12c requests an order, allocating the order processing to the content server, which is close to the reception server 13, can suffice.

In addition, the permission ticket does not necessarily have to be encrypted. However, as in this embodiment, when the ticket part 107 in the permission ticket is encrypted and responded to the client, the fraudulent access of the client can be prevented even if the permission ticket is notified to the client through the Internet 11, thereby improving the security.

Additionally, subjecting the permission ticket to appropriate encryption processing can prevent falsification of the permission ticket by a user. Although the content servers 14 inspect cipher, using the permission ticket which can be inspected without generating communication processing with the reception server 13 can prevent increase in load of the reception server 13.

On the contrary, if not necessary in view of the system configuration, it may be configured so as not to perform any access authentication process. FIG. 8 shows an example of the structure of permission ticket corresponding to this case. In FIG. 8, reference numeral 102 denotes an address part of the content server and 103 denotes a part indicating detailed location of the content in the content server. The content server absolutely responds to the access request from the client accessing thereto by using the permission ticket, and transmits the content.

Another example of the system configuration relating to the permission ticket may set the access term of validity to the permission ticket. In FIG. 9, reference numeral 112 shows the access term of validity. According to this example, the contents server will be restricted by 23:59 on Sep. 28, 2001, and will receive access of the 1 time or multiple times from the regular client.

Still another examples of the system configuration about the permission ticket, as shown in FIG. 10, may specify the time zone of access to be the permission ticket.

In FIG. 10, reference numeral 117 shows the access permission start time and the finish time. According to this example, the contents server will be restricted by 23:59 from 13:00 on Sep. 28, 2001, and will receive access of the 1 time or multiple times from the regular client.

By shortening the time from start of the access permission to end of the same, it is possible to avoid catch-out or falsification of the permission ticket when a long period of time passes after issue of the permission ticket, thereby further improving the security.

According to the above described embodiment of the present invention, there is provided a distributed order reception system, which distributes appropriately the load of the contents server due to the access request, which relates to the order from the client without the load to the specific content server becoming relatively high. In particular, according to the embodiment, the client process can easily be realized by utilizing the existing WWW browser without changing.

Meanwhile, in the above embodiment, if all the content servers are busy, this fact is simply displayed to the client, namely, the order is denied. However, when there is adopted a structure such that the time till an available content server is obtained is estimated from the busy state and the client is again allowed to access after elapse of the estimated time, the affinity to the user is high.

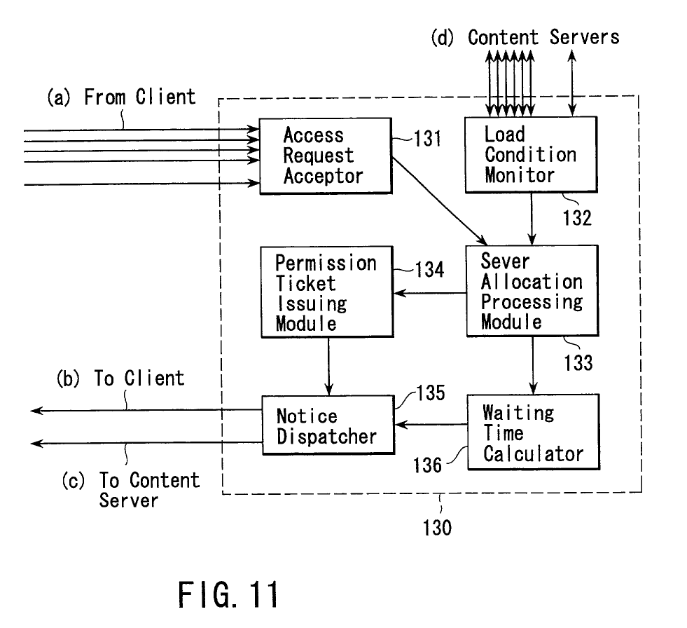

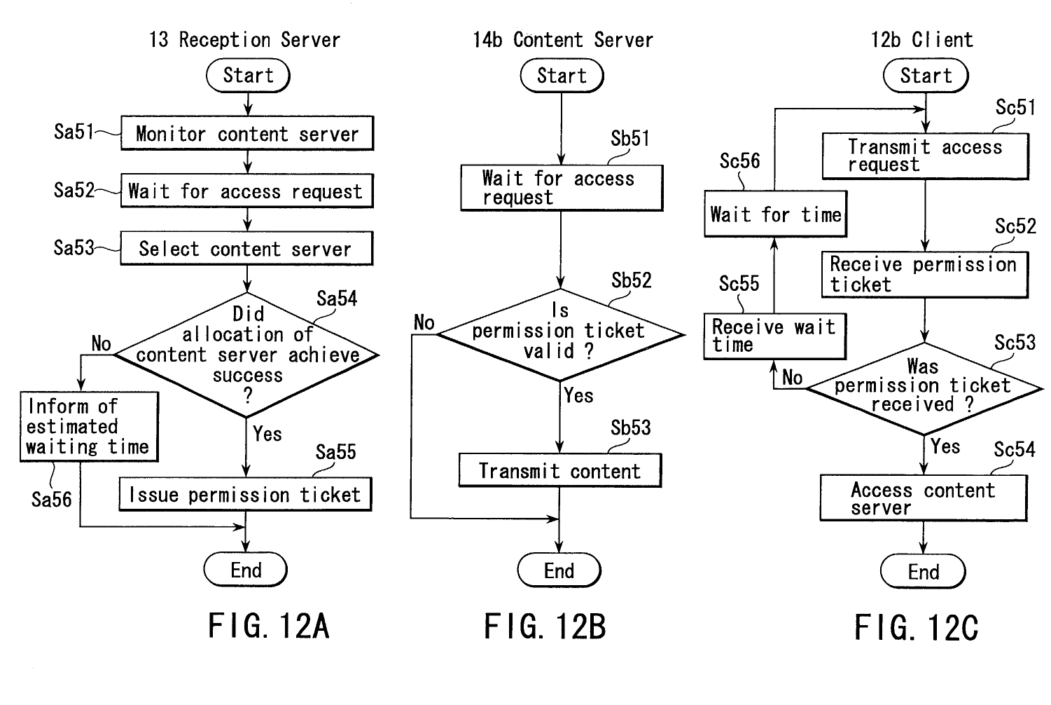

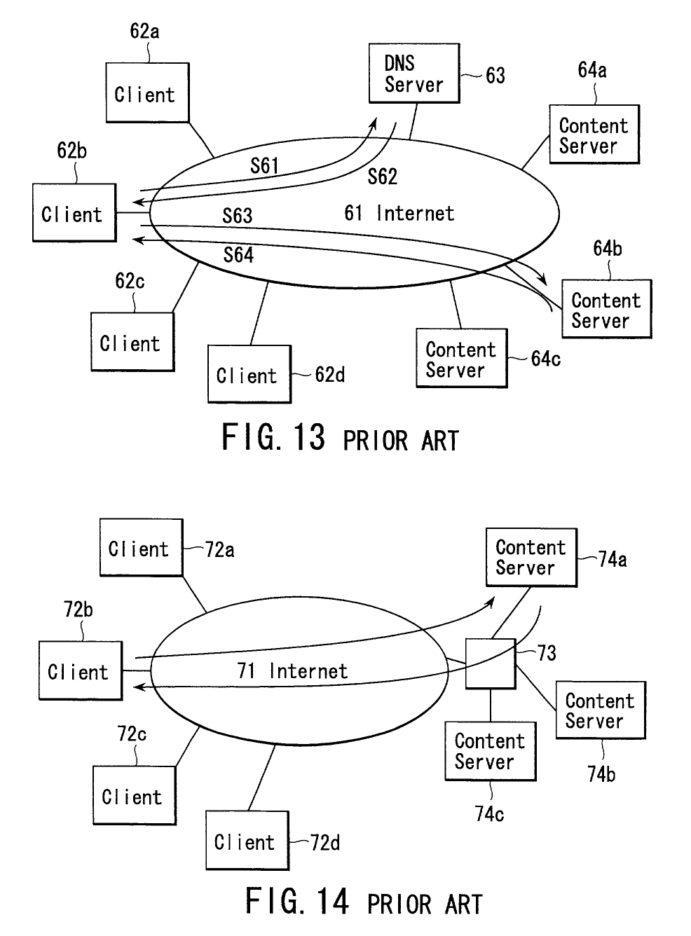

Another embodiment will now be described with reference to FIGS. 11 to 12C.

FIG. 11 is a block diagram showing modules of a reception server to provide for a load sharing functionality according to another embodiment of the present invention. The basic configuration of the system presupposes that it is the same as that of what is shown in FIG. 1. Also in this embodiment, it is assumed that an access is made from the client 12b. FIGS. 12A to 12C are flowcharts showing a process of a reception server, a process of a content server, and a process of a client respectively.

As shown in FIG. 12A, the reception server 13 monitors the content servers in the step Sa51. In the step Sc51, when the client 12b issues an access request to the reception server 13, the reception server 13 selects the content server (14b also in this case) in the step Sa53. In the step Sa54, when allocation to the content server 14b achieves success, the reception server 13 issues the permission ticket in the step Sa55, and the client 12b can access the content server 14b and obtain the content.

However, when all the content servers are busy, the reception server 13 cannot allocate the content server in the step Sa54. Therefore, in this embodiment, the time till an available content server is obtained is estimated from the current busy state and the estimated time is notified in the step Sa56.

This estimated a waiting time calculator 136 shown in FIG. 11 could calculate waiting time. The waiting time calculator 136 may estimate a throughput per unit time from a memory quantity used by the content server whose load is minimum, or calculates an average from the record of the required times.

On the other hand, in this case, the client 12b cannot receive the permission ticket in the step Sc53 and is informed of the estimated waiting time from the reception server 13 in the step Sc55 (reception of the waiting time). After waiting for the estimated time in the step Sc56, the processing again returns to the step Sc51, and the client 12b automatically issues an access request. Since this access request is transmitted after the estimated waiting time, the possibility that any content server is available is high.

The subsequent process is the same as that in the above embodiment. If the content servers are busy when access is made after the estimated waiting time, the process for estimating the waiting time is again carried out in the step Sa54. The calculated estimation time is notified to the client, and the similar process is repeated.

Incidentally, if connection achieves success as a result of a reconnection access request, by notifying a user of success of connection by sounds and the like from the client 12b can cause the user to further rapidly start access to the content server, which is more preferable.

According to the above-described embodiments of the present invention, it is possible to provide a distributed order processing system and method capable of appropriately distributing loads even if orders are rushing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An order reception and content transmission system configured to accept an order for a content, which is requested from a client via a network, the system comprising:
a reception server configured to issue a permission ticket to the client upon receiving a first access request relating to the order from the client; and
a content server configured to transmit the content to the client in response to a second access request sent from the client using the permission ticket.

2. An order reception and content transmission system configured to accept an order for a content, which is requested from a client via a network, the system comprising:
a plurality of content servers each of which stores the same content; and
a reception server having a first device configured to select one of the content servers based on load conditions thereof, a second device configured to receive a first access request relating to the order from the client, and a third device configured to issue a permission ticket to the client, wherein the permission ticket locates said selected one of content servers on the network.

3. The system according to claim 2, wherein the first device of the reception server monitors the load conditions of the content servers via a dedicated network.

4. The system according to claim 2, wherein the third device of the reception server specifies a time period to control an access using the permission ticket from the client.

5. In an order reception system including a reception server apparatus configured to accept an order for a content, which is requested from a client via a network, and a content server which transmits the content, the reception server apparatus for accepting the order comprising:
an acceptor configured to accept a first access request relating to the order from the client;
an issuing device configured to issue a permission ticket, wherein the permission ticket locates said content server on the network; and
a dispatcher configured to dispatch the permission ticket to the client and the notice of the issuance of the permission ticket to the content server.

6. In an order reception system configured to accept an order for a content, which is requested from a client via a network, and transmit the content from one of a plurality of content servers, each of which stores the same content, a reception server apparatus for accepting the order comprising:
a server allocation device configured to select one of the content servers based on load conditions thereof;
an acceptor configured to accept a first access request relating to the order from the client;
an issuing device configured to issue a permission ticket, wherein the permission ticket locates said selected one of content servers on the network; and
a dispatcher configured to dispatch the permission ticket to the client and the notice of the issuance of the permission ticket to said selected one of content servers.

7. The reception server apparatus according to claim 6, wherein the server allocation device monitors the load conditions of the content servers via a dedicated network.

8. The reception server apparatus according to claim 6, wherein the issuing device specifies a time period to control an access using the permission ticket from the client.

9. In an order reception system configured to accept an order for a content, which is requested from a client via a network, and issue a permission ticket relating to the content, a content sever apparatus for transmitting the content comprising:
a receiver configured to receive an access request come up with the permission ticket from the client;
a request processing device configured to process the permission ticket to confirm a validity thereof; and
a content transmitter configured to transmit the content specified by the permission ticket when the validity is confirmed.

10. A method for processing an order for a content, which is requested from a client, by a reception server and a content server, the method comprising:
issuing, under the control of the reception server, a permission ticket upon receiving a first access request relating to the order; and
transmitting, under the control of the content server, the content to the client in response to a second access request sent from the client using the permission ticket.

11. A method for processing an order for a content, which is requested from a client, by a reception server and a plurality of content servers, the method comprising:
providing same contents in each of the content servers;
under the control of the reception server, selecting one of the content servers based on load conditions thereof;
receiving a first access request relating to the order from the client; and
issuing a permission ticket, wherein the permission ticket locates said selected one of content servers on the network.

12. The method according to claim 11, further comprising:
monitoring the load conditions of the content servers via a dedicated network.

13. The method according to claim 11, further comprising:
specifying a time period to control an access using the permission ticket from the client.

14. A method for accepting an order for a content, wherein the order is requested from a client via a network and the content is provided from a content server, the method comprising:
receiving a first access request relating to the order;
issuing a permission ticket, wherein the permission ticket locates said content server on the network; and
dispatching the permission ticket to the client and the notice of the issuance of the permission ticket to the content server.

15. A method for accepting an order for a content, wherein the order is requested from a client via a network and the content is provided from one of a plurality of content servers, the method comprising:
selecting one of the content servers based on load conditions thereof;
accepting a first access request relating to the order;
issuing a permission ticket, wherein the permission ticket locates said selected one of content servers on the network;
dispatching the notice of the issuance of the permission ticket to said selected one of content servers; and
dispatching the permission ticket to the client.

16. The method according to claim 15, further comprising:
monitoring the load conditions of the content servers via a dedicated network.

17. The method according to claim 15, further comprising:
specifying a time period to control an access using the permission ticket from the client.

18. A method for providing a content relating to an order requested from a client via a network, the method comprising:
issuing, in response to a request from the client, a permission ticket relating to the content in advance;
receiving an access request come up with the permission ticket from the client;
processing the permission ticket to confirm a validity thereof; and
transmitting the content specified by the permission ticket when the validity is confirmed.

19. A recording medium having thereon a computer readable program for enabling a computer to accept an order for a content, which is requested from a client via a network, and transmit the content from a content server, said program for accepting the order comprising:
code means for accepting a first access request relating to the order from the client;
code means for issuing a permission ticket, wherein the permission ticket locates said content server on the network; and
code means for dispatching the permission ticket to the client and the notice of the issuance of the permission ticket to the content server.

20. A recording medium having thereon a computer readable program for enabling a computer to provide a content relating to an order requested from a client via a network, said program comprising:
code means for issuing, in response to a request from the client, a permission ticket relating to the content in advance;
code means for receiving an access request come up with the permission ticket from the client;
code means for processing the permission ticket to confirm a validity thereof; and
code means for transmitting the content specified by the permission ticket when the validity is confirmed.
